(19) United States
(12) Patent Application Publication
(10) Pub. No.: US 2017/0256285 A1
(43) Pub. Date: Sep. 7, 2017

(54) VIDEO PROCESSING METHOD AND VIDEO PROCESSING SYSTEM

(71) Applicant: Sercomm Corporation, Taipei City (TW)

(72) Inventor: Shao-Hai Zhao, Jiangsu Province (CN)

(21) Appl. No.: 15/398,107

(22) Filed: Jan. 4, 2017

(30) Foreign Application Priority Data
Mar. 1, 2016 (CN) 201610114735.6

(51) Int. Cl. G11B 27/031; G11B 27/22; G06K 9/00; G11B 20/00; G06T 3/40; H04N 5/907

(52) U.S. Cl. CPC G11B 27/031; G06T 3/40; H04N 5/907; G06K 9/00718; G06K 9/00751; G11B 20/00007; G11B 27/22; G11B 2020/00072

(57) ABSTRACT

A video processing method and a video processing system for processing an original video are provided. The original video includes a plurality of original frames. The video processing method includes the following steps: A dynamic object is detected in the original video and a plurality of interesting regions in some of the original frames is obtained according to the dynamic object. Some of the original frames are cropped to obtain a plurality of cropped sub-frames according to the interesting regions. Each of the cropped sub-frames is resized to obtain a plurality of resized sub-frames whose resolutions are identical. The resized sub-frames are compressed to be an interesting video.

This application claims the benefit of People's Republic of China application Serial No. 201610114735.6, filed Mar. 1, 2016, the disclosure of which is incorporated by reference herein in its entirety.

### TECHNICAL FIELD

The disclosure relates in general to a processing method and a processing system, and more particularly to a video processing method and a video processing system.

### BACKGROUND

Along with the development of video technology, various video cameras are invented. The video cameras are widely used in several applications, such as environment monitoring, driving recording, and network video chatting.

Because video data is composed of several continuous frames, the amount of the video data is quite large. The video data usually occupies a large storage space and needs large bandwidth to be transmitted. Therefore, it is a bottleneck to develop the video technology.

### SUMMARY

The disclosure is directed to a video processing method and a video processing system. The original frames are partially compressed according to a plurality of interesting regions, such that the amount of the video data is reduced and the content is still clear.

According to one embodiment, a video processing method for processing an original video is provided. The original video includes a plurality of original frames. The video processing method includes the following steps: A dynamic object is detected in the original video and a plurality of interesting regions in some of the original frames is obtained according to the dynamic object. Some of the original frames are cropped to obtain a plurality of cropped sub-frames according to the interesting regions. Each of the cropped sub-frames is resized to obtain a plurality of resized sub-frames whose resolutions are identical. The resized sub-frames are compressed to be an interesting video.

According to another embodiment, a video processing system for processing an original video is provided. The original video includes a plurality of original frames. The video processing system includes a detecting unit, a cropping unit, a resizing unit and a compressing unit. The detecting unit is for detecting a dynamic object in the original video and obtaining a plurality of interesting regions in some of the original frames according to the dynamic object. The cropping unit is for cropping some of the original frames to obtain a plurality of cropped sub-frames according to the interesting regions. The resizing unit is for resizing each of the cropped sub-frames to obtain a plurality of resized sub-frames whose resolutions are identical. The compressing unit is for compressing the resized sub-frames to be an interesting video.

### BRIEF DESCRIPTION OF THE DRAWINGS

FIG. 1 shows a video processing system.

FIG. 2 shows a flowchart of a video processing method according to one embodiment.

FIGS. 3A to 3D show an example illustrating the steps in FIG. 2.

FIGS. 4A to 4D show another example illustrating the steps in FIG. 2.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

In one embodiment of the present invention, some original frames corresponding with a plurality of interesting regions (also called as regions of interest or regions of attention) are partially compressed, such that the amount of data can be reduced and the content in the interesting regions is still clear.

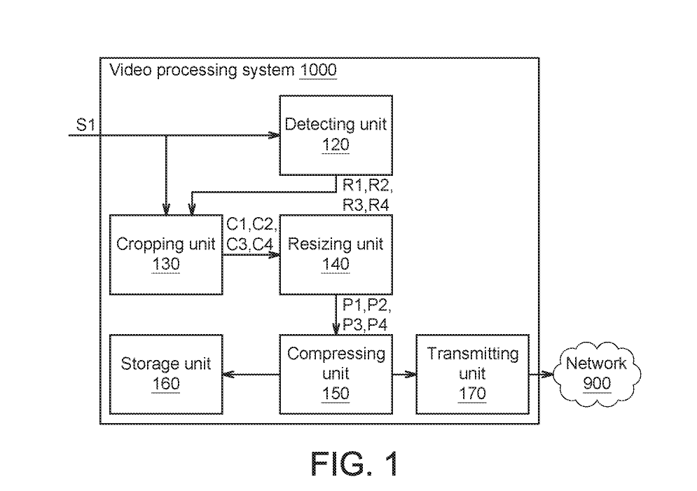

Please refer to FIG. 1, which shows a video processing system 1000. For example, the video processing system 1000 may be an Internet Protocol camera, a server, a computer, a computer cluster or a system composed of a video camera and a server.

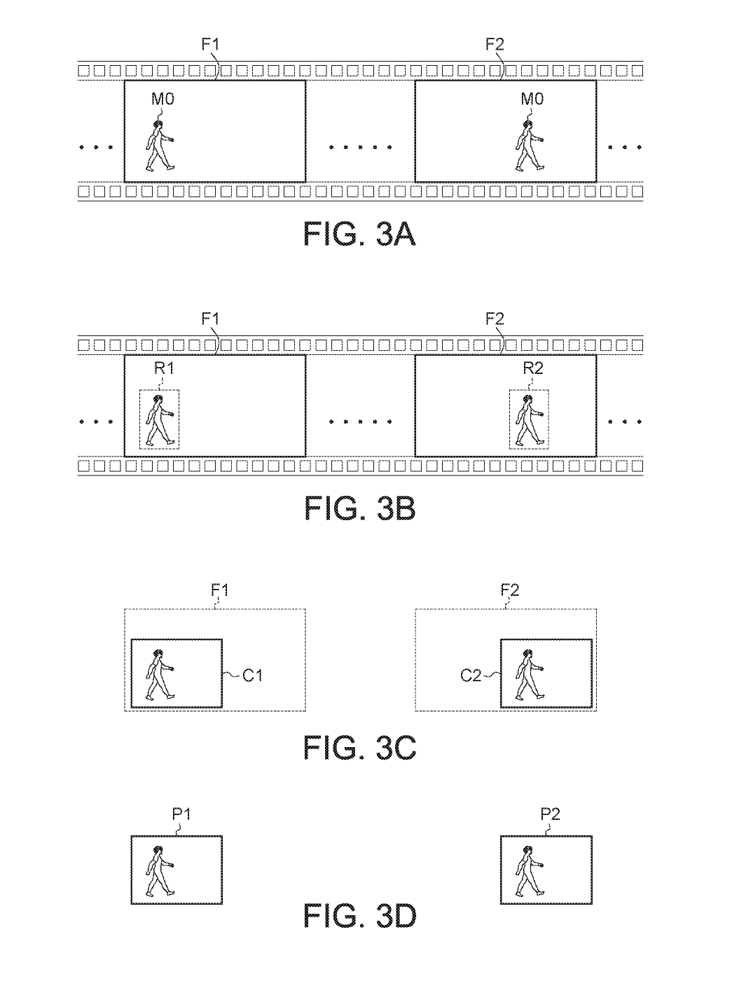

The video processing system 1000 includes a detecting unit 120, a cropping unit 130, a resizing unit 140, a compressing unit 150, a storage unit 160 and a transmitting unit 170. The video processing system 1000 is used for processing an original video S1. The original video S1 includes a plurality of original frames, such as original frames F1, F2 in FIG. 3A. The original video S1 may be obtained from a storage device or captured by a video camera. The detecting unit 120 is used for detecting a dynamic object M0 (shown in FIG. 3A) in the original video S1. The detecting unit 120 may perform an algorithm on the original video S1 to detect the dynamic object M0 in the original video S1. For example, the detecting unit 120 may be a circuit, a chip, a circuit board, a computer, or a storage device storing a plurality of program codes. Or, the detecting unit 120 may detect the physical environment to obtain an environment detection result and find the dynamic object M0 in the original video S1 according to the environment detection result. For example, the detecting unit 120 may be an infrared detector or a laser detector.

The cropping unit 130 is used for performing a frame cropping process. The resizing unit 140 is used for performing a frame resizing process. The compressing unit 150 is used for performing a compressing process. Each of the cropping unit 130, the resizing unit 140, and the compressing unit 150 may be circuit, a chip, a circuit board, a computer, or a storage storing a plurality of program codes. The detecting unit 120, the cropping unit 130, the resizing unit 140, and the compressing unit 150 may be integrated to be 1 to 3 pieces.

The storage unit 160 is used for storing various data. For example, the storage unit 160 may be a memory, a hard disk or a memory card. The transmitting unit 170 is used for transmitting data to network 900. For example, the transmitting unit 170 may be a wired network transmission module or a wireless network transmission module. One of the storage unit 160 and the transmitting unit 170 may be omitted in one embodiment.

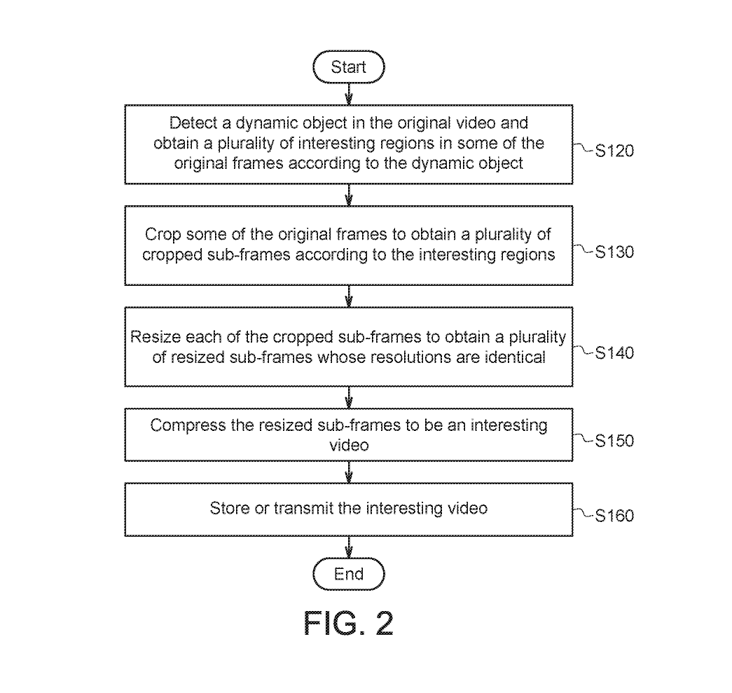

The operation of the video processing system 1000 is illustrated via a flowchart. Please refer to FIG. 2, which shows a flowchart of a video processing method according to one embodiment. The video processing method is not limited to the sequence of the steps in FIG. 2. In one embodiment, some of the steps may be integrated to be one step and may be performed at the same time. Or, in one embodiment, some of the steps may be omitted.

Please refer to FIGS. 3A to 3D, which show an example illustrating the steps in FIG. 2. In one embodiment, the original video S1 may be captured by an IP camera which is installed near a home entrance for monitoring whether there is an intruder.

The original video S1 may be a raw data which is not compressed. As shown in FIG. 3A, the original frame F1 and the original frame F2 in the original video S1 are captured at different time. For example, the resolution of the original frame F1 and the original frame F2 is 1280×720.

In step S120, as shown in FIGS. 3A to 3B, the detecting unit 120 detects the dynamic object M0 in the original video S1, and obtains an interesting region R1 in the original frame F1 and an interesting region R2 in the original frame F2 according to the dynamic object M0. The detecting unit 120 may perform an analyzing process on the original video S1 to detect the dynamic object M0. For example, a dynamic analysis algorithm may be used to obtain a difference between the original frame F1 and a previous original frame (not shown) to find out which parts are dynamic foregrounds, and which parts are static backgrounds. The detecting unit 120 may deem the largest of the dynamic foregrounds as the dynamic object M0.

Or, the detecting unit 120 may detect the physical environment to obtain an environment detection result. For example, the detecting unit 120 may detect whether there is a moving object in a particular range via an infrared detecting technology or a laser detecting technology. Then, the detecting unit 120 maps the environment detection result on the original video S1 to find the location and the size of the dynamic object M0 in the original video S1.

In the present embodiment, an image taking direction of the camera is fixed when the original video S1 is captured by the video camera. Therefore, when the dynamic object M0 moves in front of the video camera, the location of the interesting region R1 and the location of the interesting region R2 maybe different (as shown in FIG. 3B).

In step S130, as shown in FIG. 3C, the cropping unit 130 respectively crops the original frame F1 and the original frame F2 to obtain a cropped sub-frame C1 and a cropped sub-frame C2 according to the interesting region R1 and the interesting region R2. The aspect ratio of the cropped sub-frame C1 and the aspect ratio of the cropped sub-frame C2 are the same. For example, the aspect ratio may be 4:3.

In step S140, as shown in FIGS. 3C to 3D, the resizing unit 140 resizes the cropped sub-frame C1 and the cropped sub-frame C2 to obtain a resized sub-frame P1 and a resized sub-frame P2 respectively. The resolution of the resized sub-frame P1 and the resolution of the resized sub-frame P2 are identical, such as 640×480. The resolution of the resized sub-frame P1, such as 640×480, is less than the resolution of the original frame F1, such as 1280×720. The resolution of the resized sub-frame P2, such as 640×480, is less than the resolution of the original frame F2, such as 1280×720.

In step S150, the compressing unit 150 compresses the resized sub-frame P1 and the resized sub-frame P2 to be an interesting video. For example, the compressing unit 150 performs the compressing process according to the H.264 standard.

Next, in step S160, the interesting video can be stored in the storage unit 160 at a local device; or the interesting video can be transmitted to a remote device through the network 900 by the transmitting unit 170.

As such, even if the dynamic object M0 moves in front of the video camera constantly, the dynamic object M0 still can be recorded within low amount of data by the video processing system 1000 and the video processing method described above.

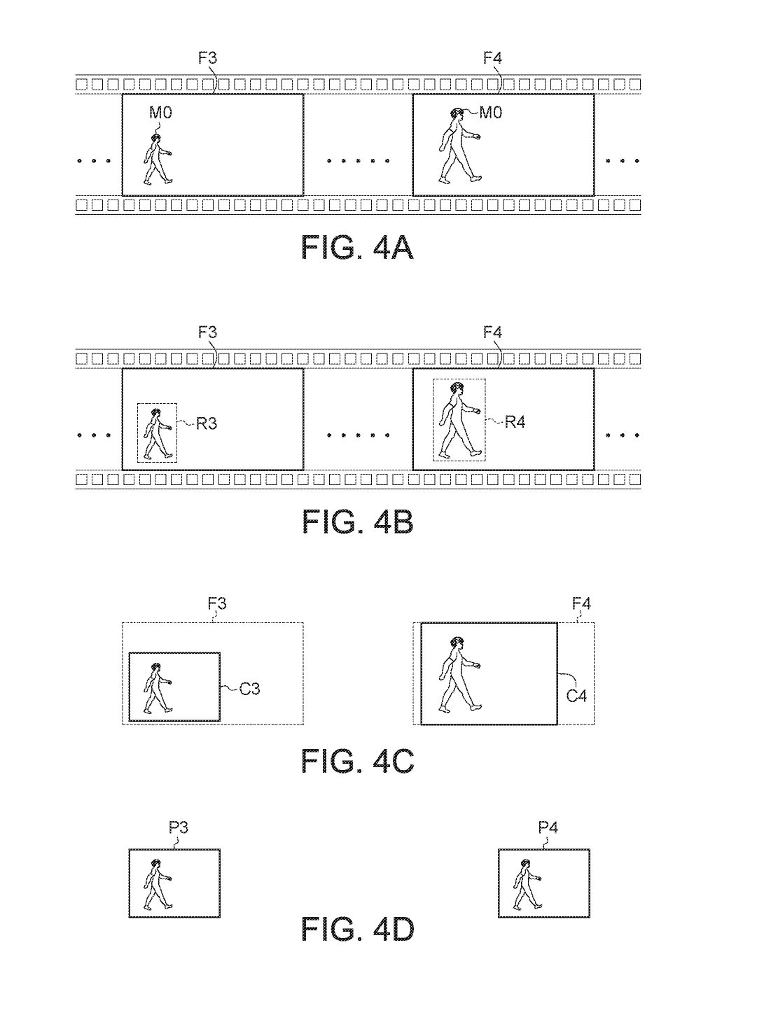

Please refer to FIGS. 4A to 4D, which show another example illustrating the steps in FIG. 2. As shown in FIGS. 4A to 4B, a zooming rate of the video camera is fixed when the original video S1 is captured by the video camera. If the dynamic object M0 moves away or approaches the video camera, the size of an interesting region R3 and the size of an interesting region R4 may be different.

Next, as shown in FIGS. 4B to 4C, the cropping unit 130 crops an original frame F3 to obtain a cropped sub-frame C3 according to the interesting region R3 and crops an original frame F4 to obtain a cropped sub-frame C4 according to the interesting region R4. The aspect ratio of the cropped sub-frame C3 and the aspect ratio of the cropped sub-frame C4 are identical, but the resolution of the cropped sub-frame C3 and the resolution of the cropped sub-frame C4 may not be identical. For example, the resolution of the interesting region R3 is 640×480, and the resolution of the cropped sub-frame C4 is 960×720.

Then, as shown in FIGS. 40 to 4D, the resizing unit 140 resizes the cropped sub-frame C3 and the cropped sub-frame C4, to obtain a resized sub-frame P3 and a resized sub-frame P4 whose resolutions are identical. After obtaining the resized sub-frame P3 and the resized sub-frame P4 whose resolutions are identical, the compressing process can be performed correctly.

As such, even if the dynamic object M0 moves away or approaches the video camera, the dynamic object M0 still can be recorded within low amount of data by the video processing system 1000 and the video processing method described above.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A video processing method, for processing an original video including a plurality of original frames, wherein the video processing method comprises:
detecting a dynamic object in the original video and obtaining a plurality of interesting regions in some of the original frames according to the dynamic object;
cropping some of the original frames to obtain a plurality of cropped sub-frames according to the interesting regions;
resizing each of the cropped sub-frames to obtain a plurality of resized sub-frames whose resolutions are identical; and
compressing the resized sub-frames to be an interesting video.

2. The video processing method according to claim 1, wherein the interesting regions are not located at the same location in the original frames.

3. The video processing method according to claim 1, wherein the original video is captured by a video camera whose image taking direction is fixed, and the interesting regions are moved along with the dynamic object.

4. The video processing method according to claim 1, wherein the original video is captured by a video camera whose zooming rate is fixed.

5. The video processing method according to claim 1, wherein the resolutions of the cropped sub-frames are not identical.

6. The video processing unit according to claim 1, wherein the resolution of each of the resized sub-frames is less than the resolution of each of the original frames.

7. A video processing system, for processing an original video including a plurality of original frames, wherein the video processing system comprises:
a detecting unit for detecting a dynamic object in the original video and obtaining a plurality of interesting regions in some of the original frames according to the dynamic object;
a cropping unit for cropping some of the original frames to obtain a plurality of cropped sub-frames according to the interesting regions;
a resizing unit for resizing each of the cropped sub-frames to obtain a plurality of resized sub-frames whose resolutions are identical; and
a compressing unit for compressing the resized sub-frames to be an interesting video.

8. The video processing system according to claim 7, wherein the interesting regions are not located at the same location in the original frames.

9. The video processing system according to claim 7, further comprising a video camera for capturing the original video, wherein an image taking direction of the video camera is fixed, and the interesting regions are moved along with the dynamic object.

10. The video processing system according to claim 7, further comprising a video camera for capturing the original video, wherein a zooming rate of the video camera is fixed.

11. The video processing system according to claim 7, wherein the resolutions of the cropped sub-frames are not identical.

12. The video processing system according to claim 7, wherein the resolution of each of the resized sub-frames is less than the resolution of each of the original frames.
